(19) United States
(12) Patent Application Publication
(10) Pub. No.: US 2007/0091977 A1
(43) Pub. Date: Apr. 26, 2007

(54) Method and system for forming periodic pulse patterns

(75) Inventors: Ik Bu Sohn, Daejeon (KR); Man Seop Lee, Daejeon (KR)

Correspondence Address: BACON & THOMAS, PLLC, 625 SLATERS LANE, FOURTH FLOOR, ALEXANDRIA, VA, 22314, US

(73) Assignee: RESEARCH AND INDUSTRIAL CORPORATION GROUP, Daejeon (KR)

(21) Appl. No.: 11/412,919

(22) Filed: Apr. 28, 2006

(30) Foreign Application Priority Data
Oct. 12, 2005 (KR) 10-2005-0096039

(51) Int. Cl. H01S 3/00

(52) U.S. Cl. 372/109

(57) ABSTRACT

A system for forming a periodic pulse pattern in a sample includes a movable stage having the sample loaded thereon, a pulse laser for generating a laser beam of pulses, an objective lens for focusing the laser beam to the sample to form a pattern of pulses in the sample, and a controller for adjusting the movement speed of the movable stage to set a period of the pulse pattern. The pulse pattern includes a spot pattern or a line pattern made by a slit provided between the pulse laser and the objective lens.

### FIELD OF THE INVENTION

The present invention relates to a method and a system of forming patterns using an ultrashot pulse laser, and more particularly, to a method and system of forming a periodic pulse pattern of a spot or a line using an ultrashot pulse laser in manufacturing band-gap structured Bragg gratings.

### BACKGROUND OF THE INVENTION

As is known in the art, optical devices such as an optical waveguide and Bragg grating are widely applied in long-distance communications. The optical waveguide is used to transmit a large amount of optical information over a long distance with low signal attenuation through a core having a relatively high refractive index, which is surrounded by a clad having a low refractive index. The Bragg grating acts as a band limitation filter for separating light beams of a particular wavelength band, and is utilized for a wide variety of applications such as a reflector, a wavelength stabilization device for a laser disc, an optical fiber laser, and an optical sensor.

Optical devices such as an optical waveguide and Bragg diffraction grating are normally fabricated using a laser of ultraviolet (UV) rays. In recent, a direct-writing technique has been reported to form an optical waveguide or Bragg grating within a transparent sample using an ultrashot speed pulse laser, for example, a femtosecond laser. It is further reported that the femtosecond laser can also be used to make permanent changes in refractive indexes of various glass materials. These glass materials having a changed refractive index can be used for the fabrication of waveguides, Bragg gratings and couplers.

U.S. Pat. No. 5,761,111 issued to Glezer discloses a femtosecond lasing technique in which two- or three-dimensional optical information storage are fabricated in a glass by way of making volume elements (voxels), each voxel ranging from several microns to several millimeters in length and sub-micron to several microns in diameter.

Another femtosecond lasing technique is disclosed in U.S. Pat. No. 5,978,538 issued to Miura, et al., in which a femtosecond laser is used to fabricate an optical waveguide made of oxide glass, halide glass and chalcogenide glass.

In addition, a method of fabricating long-period fiber gratings, through the use of focused irradiation of infrared femtosecond laser pulses, has been reported by Kondo, et al., in Optics Letters 24(10), pp. 646-648.

However, in fabrication of optical devices such as an optical waveguide, in particular, Bragg grating through irradiation of successive pulse train, a conventional direct-writing technique utilizing a femtosecond laser requires a long processing time to individually scan several thousands of patterns one at a time in order to pattern the glass, and results in reduction of machining stability owing to the long machining time.

### SUMMARY OF THE INVENTION

Therefore, an object of the present invention is to provide a method and a system of periodically forming a pulse pattern such as a spot or a line in a sample using a pulse laser.

In accordance with one aspect of the invention, there is provided a system for forming a periodic pulse pattern in a sample, comprising:

a movable stage having the sample loaded thereon;

a pulse laser for generating a laser beam of pulses;

means for focusing the laser beam to the sample to form a pattern of pulses in the sample; and

a controller for adjusting the movement speed of the movable stage to set a period of the pulse pattern.

In accordance with another aspect of the invention, there is provided a method for forming a periodic pulse pattern in a sample, comprising the steps of:

loading the sample on a movable stage;

generating a laser beam of pulses from a pulse laser;

focusing the laser beam to the sample using a beam focusing lens; and

adjusting the movement speed of the movable stage so that the laser beam is scanned in the sample, to thereby form the periodic pulse pattern in the sample.

### BRIEF DESCRIPTION OF THE DRAWINGS

The above and other objects and features of the present invention will become apparent from the following description of preferred embodiments given in conjunction with the accompanying drawings, in which:

FIG. 1 shows a block diagram of a system to form a periodic spot pattern in accordance with a preferred embodiment of the present invention;

FIG. 2 is a schematic diagram illustrating a procedure to form a periodic spot pattern using the system shown in FIG. 1;

FIG. 3 is a photograph, taken by an optical microscope, showing a variety of spot patterns having different periods fabricated through the procedure in FIG. 2;

FIG. 4 is a flow chart illustrating a method to form a periodic pulse pattern using the system shown in FIG. 1;

FIG. 5 shows a block diagram of a system to form a periodic line pattern in accordance with another embodiment of the present invention;

FIG. 6 is a schematic diagram illustrating a procedure to form the periodic line pattern using the system shown in FIG. 5;

FIGS. 7 and 8 are photographs, taken by an optical microscope, showing line patterns having different periods fabricated through the procedure in FIG. 6; and

FIG. 9 is a flow chart illustrating a method to form the periodic line pattern using the system shown in FIG. 5.

### DETAILED DESCRIPTION OF THE PREFERRED EMBODIMENTS

Hereinafter, preferred embodiments of the present invention will be described in detail with reference to the accompanying drawings.

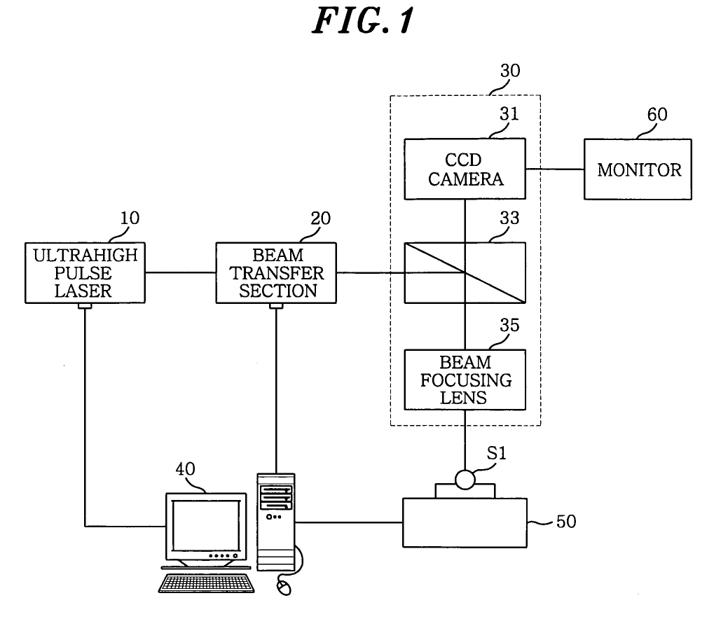

Referring to FIG. 1, there is shown a block diagram of a system for forming a single pulse pattern in a sample according to a preferred embodiment of the present invention. The system comprises an ultrashot pulse laser 10, a laser beam delivery section 20, an optical mirror array 30, a controller 40, a movable stage 50, and a monitor 60.

A sample S1 is loaded on the movable stage 50. The sample S1 may include, for example, a silica, glass, polymer, LithiumNiobate (LiNbO₃), metal and the like.

The movable stage 50 is movable in a predetermined direction with the sample S1 loaded thereon under the control of the controller 40.

The ultrashot pulse laser 10, for example, an ultrahigh speed femtosecond laser, generates a laser beam of one thousand ultrashot pulses per second under the control of the controller 40. The laser beam has 800 nm in wavelength, 100 fs in pulse width, and 1 kHz in repetition rate, and is transmitted to the beam delivery section 20.

The beam delivery section 20 functions to relay the laser beam having a train of the ultrashot pulses from the ultrashot pulse laser 10 to the optical mirror array 30.

The optical mirror array 30 serves to focus the laser beam and to irradiate the focused laser beam to the sample S1 on the movable stage 50. The optical mirror array 30 includes a charge coupled device (CCD) camera 31, a beam splitter 33 and a beam focusing lens 35.

The beam splitter 33 directs the laser beam provided from the beam delivery section 20 to the beam focusing lens 35 and the CCD camera 31.

The beam focusing lens 35, which is implemented with an objective lens, focuses the laser beam provided through the beam splitter 33. The focused beam is represented in the form of a circular beam. Then the focused circular beam is irradiated to the sample S1 on the movable stage 50.

When the laser beam is focused to the sample S1, a modification of optical properties is made along the optical axis of the laser beam. The visible laser damage can be formed only the region focused in the sample because nonlinear optical processes, such as multi-photon absorption, occur in regions with high optical intensity above the damage threshold. The damaging involves microexplosion at a focal spot, which leaves nearly-spherical empty or rarefied volume in the bulk of the sample. Modification of the sample is visible in a transmitted light optical microscope. The spherical empty or rarefied volume is observed as a continuous repeated pattern.

Moreover, in case where the movement speed of the movable stage is controlled, the period of the pattern is also controlled.

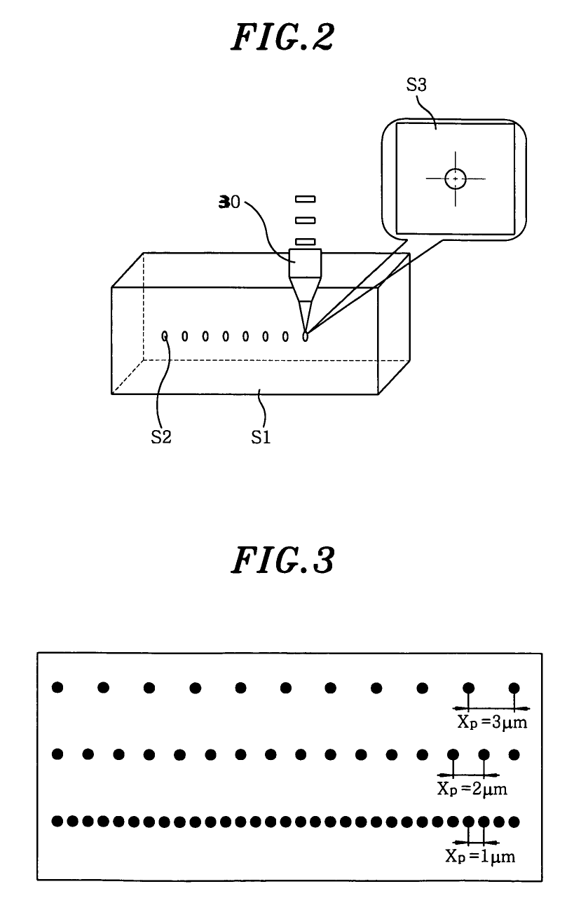

As best shown in FIG. 2, there is illustrated a procedure wherein a circular beam S3 is formed by the beam focusing lens 35 and a periodic spot pattern S2 are then formed while adjusting the movement speed of the movable stage 50. At this time, the size and depth of each circular spot S3 is properly changed through adjusting the magnification and numerical aperture of the beam focusing lens 35 and adjusting the power density of the ultrashot pulse laser beam emitted by the ultrashot pulse laser 10.

The controller 40 is adapted to control generation and transmission of the ultrashot pulse laser beam and adjust the movement speed of the movable stage 50.

Under the movement speed control of the controller 40, the spot pattern S2 is formed in the sample S1 to have a desired period corresponding to the movement speed. For example, in the case when the repetition rate of the ultrashot pulse laser beam is 1 kHz, as shown in FIG. 3, if the movement speed of the movable stage 50 is set to 1 mm/sec, 2 mm/sec and 3 mm/sec, the period Xp of the spot pattern S2 becomes 1 μm, 2 μm and 3 μm, respectively.

The CCD camera 31 captures an image of the periodic spot pattern S2, which are formed in the sample S1. Then, the CCD camera 31 sends the captured image of the spot pattern to the monitor 60. The monitor 60 outputs the image captured by the CCD camera 31 to display a visual image for the user.

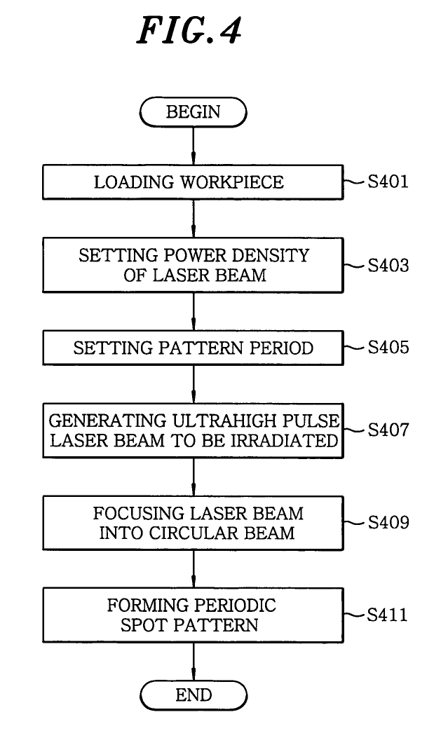

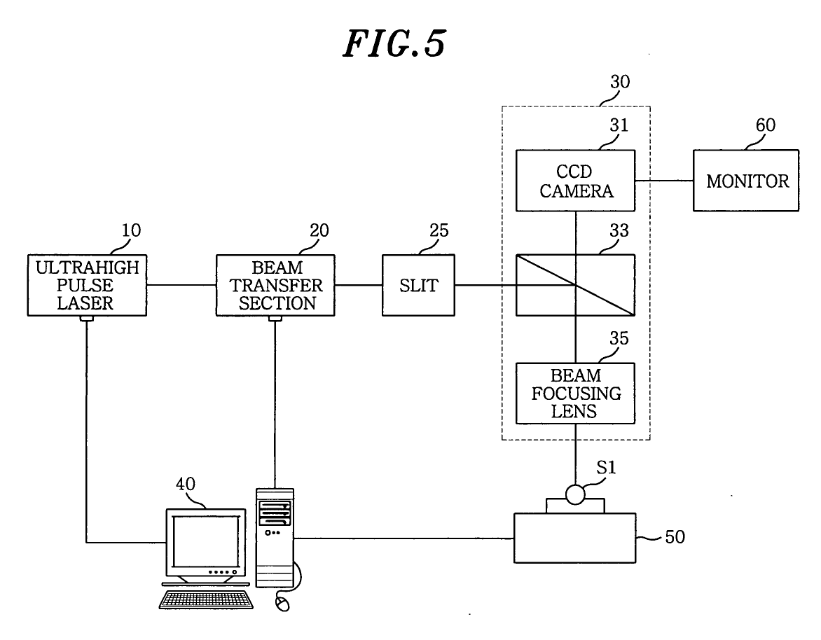

The method of forming a periodic spot pattern will be described with reference to FIG. 4.

Firstly, in S401, a sample S1 to be patterned is loaded on the movable stage 50. Using the controller 40, the power density of a laser beam to be generated by the ultrashot pulse laser 10 is determined. And then, in consideration of the repetition rate of the laser beam, the movement speed of the movable stage 50 is adjusted to set the desired period of the spot pattern S2 in S405. The movement speed of the movable stage 50 may be adjusted arbitrarily by a user. For example, as shown in FIG. 3, if the movement speed of the movable stage 50 is set to 1 mm/sec, 2 mm/sec and 3 mm/sec, the spot pattern S2 becomes to have pattern periods of 1 μm, 2 μm and 3 μm, respectively.

Afterwards, in S407, under the control of the controller 40, the ultrashot pulse laser 10 generates a laser beam and transmits the generated laser beam to the beam delivery section 20. The beam delivery section 20 relays the laser beam to the beam splitter 33 and, in turn, the beam focusing lens 35 of the optical mirror array 30.

The beam focusing lens 35 focuses the laser beam in the form of a circular beam S3 to irradiate it to the sample S1 in S409. As a result, the spot pattern S2 is periodically formed in the sample S1, to thereby fabricate Bragg diffraction gratings, one spot per laser beam pulse in S411.

At this time, an image of the spot pattern S2 is captured by the CCD camera 31 and displayed on the monitor 60.

According to the present invention, a laser beam of a single pulse is used to form the periodic spot pattern in the sample, in a manner faster than a conventional direct-writing technique.

FIG. 5 is a block diagram of a system of forming a periodic line pattern in accordance with another embodiment of the present invention. The second embodiment of FIG. 5 has the same configuration as that of the first embodiment of FIG. 1, except that a slit 25 is provided between a beam delivery section 20 and an optical mirror array 30. Therefore, a detailed description thereof will be omitted for the sake of simplicity of the present invention.

The operation of the second embodiment will be explained with reference to FIGS. 5 to 8 as follows.

As similar as the first embodiment of the present invention, an ultrashot pulse laser 10 generates an ultrashot pulse laser beam, which will then be transmitted through the beam delivery section 20 to the slit 25.

The slit 25 is used to provide a line pattern and a size of the slit 25 ranges from 0.5 to 1 mm. The laser beam is changed into a slit beam passing through the slit 25. The slit beam is provided to an optical mirror array 30.

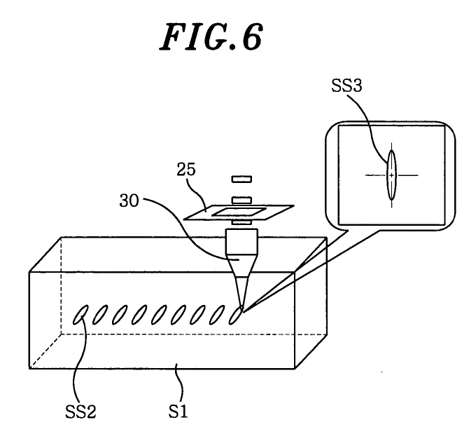

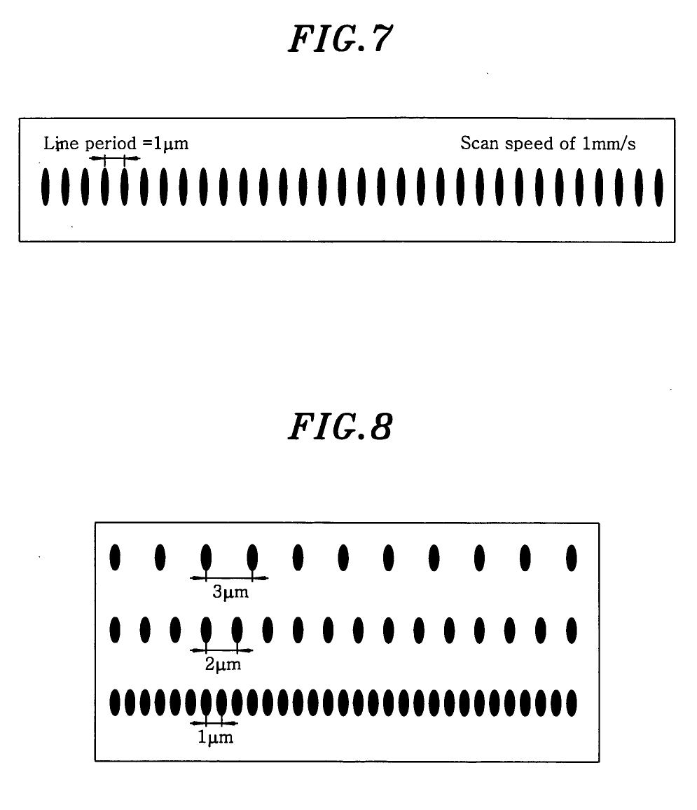

In the optical mirror array 30, a beam splitter 33 transmits the slit beam to the beam focusing lens 35. The beam focusing lens 35 focuses the slit beam Figto irradiates a line shaped beam SS3 shown in FIG. 6 toward the sample S1. Accordingly, a line pattern SS2 is then formed in the sample S1. Here, the size, width and depth of each line pattern SS2 is properly changed, as shown in FIG. 7, through adjusting the magnification of the beam focusing lens 35, the power density of the ultrashot pulse laser beam from the ultrashot pulse laser 10, and the gap of the slit 25. Fig A controller 40 functions to control generation and transmission of the laser beam and adjust the movement speed of the movable stage 50. Under the control of the controller 40, the line pattern SS2 is formed in the sample S1, as shown in FIGS. 7 and 8, wherein the line pattern SS2 has a desired period corresponding to the movement speed.

The monitor 60 acts to output an image of the periodic line patterns captured by the CCD camera 31 in a visual image for the user.

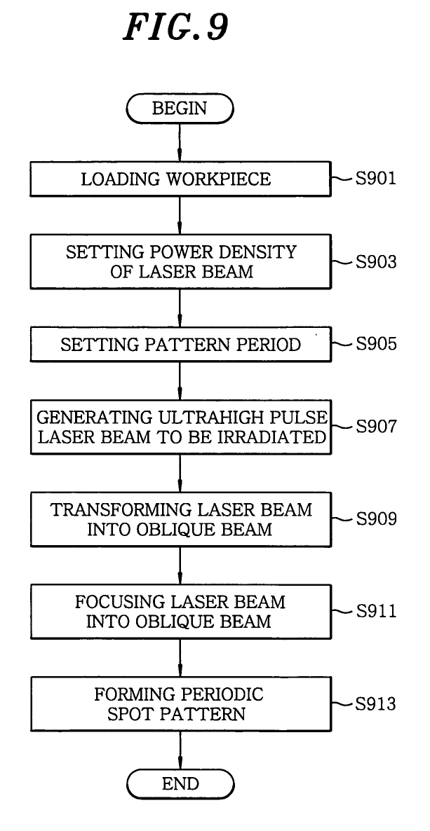

Referring to FIG. 9, there is illustrated a method of forming the line pattern performed by the system shown in FIG. 5.

Firstly, a sample S1 is loaded on the movable stage 500 in S901.

The power density of a laser beam to be generated by the ultrashot pulse laser 10 is determined S903.

In consideration of the repetition rate of the laser beam, the movement speed of the movable stage 50 is adjusted to set the period of the line pattern in S905.

Afterwards, under the control of the controller 40, the ultrashot pulse laser 10 generates the laser beam, which is then transmitted through the beam delivery section 20 to the slit 25 in S907.

In the slit 25, the laser beam is transformed into a slit beam, and is provided to the beam splitter 33 in the optical mirror array 30 in S909. Thereafter, the beam splitter 33 transmits the slit beam to the beam focusing lens 35.

The beam focusing lens 35 focuses the slit beam in the form of an oblique beam SS3 to the sample S1 in S911. Accordingly, a line pattern SS2 is periodically formed in the sample, one line pattern per pulse in S913.

At this time, an image of the periodic line patterns formed on the sample S1 is captured by the CCD camera 301 and displayed on the monitor 600 for the user.

Alternatively, a beam shaper (not shown) may be used to variously shape the laser beam in terms of form, size and direction. For example, a triangular, a rectangular or a pentagonal beam may be shaped using the beam shaper, to thereby fabricate a Bragg grating having a single pulse of triangular, rectangular or pentagonal pattern.

Although the present invention has been shown and described that the formation of the periodic pattern is applied to fabrication of the Bragg grating, it is not limited thereto but is applicable to various applications having a periodic band-gap structure such as optical memories and photonic crystals. The formation of the periodic pattern may also be used to fabricate three-dimensional fine constructions, patterns, or configurations on a surface of or inside the sample depending on the focal depth.

While the invention has been shown and described with respect to the preferred embodiments, it will be understood by those skilled in the art that various changes and modifications may be made without departing from the spirit and scope of the invention as defined in the following claims.

What is claimed is:

1. A system for forming a periodic pulse pattern in a sample, comprising:
a movable stage having the sample loaded thereon;
a pulse laser for generating a laser beam of pulses;
means for focusing the laser beam to the sample to form a pattern of pulses in the sample; and
a controller for adjusting the movement speed of the movable stage to set a period of the pulse pattern.

2. The system of claim 1, wherein the pulse pattern includes a spot pattern.

3. The system of claim 1, wherein the pulse pattern includes a line pattern.

4. The system of claim 2, wherein said focusing means includes:
an objective lens for focusing the pulse laser beam in a form of a circular spot to the sample, to thereby form the spot pattern in the sample.

5. The system of claim 3, wherein said focusing means includes:
a slit for transforming the pulse laser beam into a form of a slit beam; and
an objective lens for focusing the slit beam in a form a line to the sample, to thereby form the line pattern formed in the sample.

6. The system of claim 1, wherein the sample is selected from a group including a silica, glass, metal, polymer and LithiumNiobate (LiNbO₃).

7. The system of claim 1, wherein the pulse laser includes an ultrahigh speed femtosecond laser.

8. The system of claim 4, wherein a size and a depth of the circular beam are set by adjusting a magnification and numerical aperture of the subject lens and adjusting power density of the pulse laser.

9. The system of claim 5, wherein a size and a depth of the slit beam are set by adjusting a magnification and numerical aperture of the beam focusing lens and adjusting power density of the pulse laser.

10. The system of claim 1, wherein the periodic pattern is formed on a surface of or inside the sample depending on a focal depth.

11. A method for forming a periodic pulse pattern in a sample, comprising the steps of:
loading the sample on a movable stage;
generating a laser beam of pulses from a pulse laser;
focusing the laser beam to the sample using a beam focusing lens; and
adjusting the movement speed of the movable stage so that the laser beam is scanned in the sample, to thereby form the periodic pulse pattern in the sample.

12. The method of claim 11, wherein the pulse pattern includes a spot pattern.

13. The method of claim 11, wherein the pulse pattern includes a line pattern.

14. The method of claim 12, wherein a size and a depth of the spot pattern are set through adjusting a magnification and numerical aperture of the beam focusing lens and adjusting power density of the pulse laser.

15. The method of claim 13, wherein a size and a depth of the slit pattern are set through adjusting a magnification and numerical aperture of the beam focusing lens and adjusting power density of the pulse laser.

16. The method of claim 11, wherein the periodic pattern is formed on a surface of or inside the sample depending on a focal depth.
